(19) United States
(12) Patent Application Publication
(10) Pub. No.: US 2013/0064971 A1
(43) Pub. Date: Mar. 14, 2013

(54) METHOD FOR MAKING A CURRENT-PERPENDICULAR-TO-THE-PLANE (CPP) MAGNETORESISTIVE (MR) SENSOR WITH AN ANTIPARALLEL FREE (APF) STRUCTURE FORMED OF AN ALLOY REQUIRING POST-DEPOSITION HIGH TEMPERATURE ANNEALING

(71) Applicants: Matthew J. Carey, San Jose, CA (US); Shekar B. Chandrashekariaih, San Jose, CA (US); Jeffrey R. Childress, San Jose, CA (US); Young-suk Choi, Los Gatos, CA (US)

(72) Inventors: Matthew J. Carey, San Jose, CA (US); Shekar B. Chandrashekariaih, San Jose, CA (US); Jeffrey R. Childress, San Jose, CA (US); Young-suk Choi, Los Gatos, CA (US)

(21) Appl. No.: 13/231,608

(22) Filed: Sep. 13, 2011

(51) Int. Cl. B05D 5/00; B05D 3/02; B05D 1/38; B05D 5/12

(52) U.S. Cl. 427/123; 427/130

(57) ABSTRACT

A method for making a current-perpendicular-to-the plane magnetoresistive (CPP-MR) sensor with an antiparallel-free APF structure having the first free layer (FL1) formed of an alloy, like a Heusler alloy, that requires high-temperature or extended-time post-deposition annealing includes the step of annealing the Heusler alloy material before deposition of the antiparallel coupling layer (APC) of the APF structure. In a modification to the method, a protection layer, for example, a layer of Ru, Ta, Ti, Al, CoFe, CoFeB or NiFe, may deposited on the layer of Heusler alloy material prior to annealing, and then etched away to expose the underlying Heusler alloy layer as FL1.

### BACKGROUND OF THE INVENTION

1. Field of the Invention

The invention relates generally to a current-perpendicular-to-the-plane (CPP) magnetoresistive (MR) sensor with an antiparallel free (APF) structure that has its first free layer (FL1) formed of an alloy that requires high-temperature or extended-time annealing, like a Heusler alloy, and more particularly to a method for making the sensor.

2. Background of the Invention

One type of conventional magnetoresistive (MR) sensor used as the read head in magnetic recording disk drives is a “spin-valve” sensor based on the giant magnetoresistance (GMR) effect. A GMR spin-valve sensor has a stack of layers that includes two ferromagnetic layers separated by a nonmagnetic electrically conductive spacer layer, which is typically copper (Cu). One ferromagnetic layer adjacent the spacer layer has its magnetization direction fixed, such as by being pinned by exchange coupling with an adjacent antiferromagnetic layer, and is referred to as the reference layer. The other ferromagnetic layer adjacent the spacer layer has its magnetization direction free to rotate in the presence of an external magnetic field and is referred to as the free layer. With a sense current applied to the sensor, the rotation of the free-layer magnetization relative to the reference-layer magnetization due to the presence of an external magnetic field is detectable as a change in electrical resistance. If the sense current is directed perpendicularly through the planes of the layers in the sensor stack, the sensor is referred to as current-perpendicular-to-the-plane (CPP) sensor.

In addition to CPP-GMR read heads, another type of CPP sensor is a magnetic tunnel junction sensor, also called a tunneling MR or TMR sensor, in which the nonmagnetic spacer layer is a very thin nonmagnetic tunnel barrier layer. In a CPP-TMR sensor the tunneling current perpendicularly through the layers depends on the relative orientation of the magnetizations in the two ferromagnetic layers. In a CPP-GMR read head the nonmagnetic spacer layer is formed of an electrically conductive material, typically a metal such as Cu or Ag. In a CPP-TMR read head the nonmagnetic spacer layer is formed of an electrically insulating material, such as TiO₂, MgO or Al₂O₃.

In CPP MR sensors, it is desirable to operate the sensors at a high bias or sense current density to maximize the signal and signal-to-noise ratio (SNR). However, it is known that CPP MR sensors are susceptible to current-induced noise and instability. The spin-polarized bias current flows perpendicularly through the ferromagnetic layers and, if it is above a critical current density, produces a spin-torque (ST) effect on the local magnetization. This can produce fluctuations of the magnetization, resulting in substantial low-frequency magnetic noise if the sense current is too large. CPP MR sensors with an antiparallel free (APF) structure have been shown to have a higher critical current density, so that they are less susceptible to current-induced noise and instability. An APF structure comprises a first free ferromagnetic layer (FL1), second free ferromagnetic layer (FL2), and an antiparallel (AP) coupling (APC) layer between FL1 and FL2. The APC layer couples FL1 and FL2 together antiferromagnetically with the result that FL1 and FL2 maintain substantially antiparallel magnetization directions.

Heusler alloys, which are chemically ordered alloys like Co₂MnX (where X is one or more of Ge, Si, or Al) and Co₂FeZ (where Z is one or more of Ge, Si, Al or Ga), are known to have high spin-polarization and result in an enhanced magnetoresistance and are thus desirable materials to use in an APF structure. Heusler alloys require significant post-deposition annealing to achieve chemical ordering and high spin-polarization. Other materials whose spin-polarization is annealing-dependent are non-Heusler alloys of the form CoFeX (where X is one or more of Ge, Al, Si or Ga).

What is needed is a CPP MR sensor with an APF structure that includes a Heusler alloy or a non-Heusler alloy that requires significant annealing and a method for making the APF structure.

### SUMMARY OF THE INVENTION

The invention relates to a method for making a CPP-MR sensor with an antiparallel-free APF structure having the first free layer (FL1) formed of an alloy, like a Heusler alloy, that requires significant post-deposition annealing (greater than 250° C. or longer than 12 hours). The sensor layers, including the antiferromagnetic (AF) layer which must be annealed, up through and including the spacer layer, are deposited on the substrate. The material that will make up the Heusler alloy is then sputter deposited on the spacer layer. A high-temperature anneal is then performed before the deposition of the antiparallel coupling (APC) layer. This results in the microstructural improvement (ordering) of both the AF layer and the Heusler alloy which becomes FL1. The APC layer is deposited on the Heusler alloy FL1 layer and the non-Heusler alloy second free layer (FL2) is deposited on the APC layer. In a modification to the method, a protection layer, for example, a layer of Ru, Ta, Ti, Al, CoFe, CoFeB or NiFe, is deposited on the layer of Heusler alloy material prior to annealing. The high-temperature anneal is then performed with the protection layer covering the layer of Heusler alloy material. The protection layer is etched away to expose the underlying Heusler alloy layer as FL1.

In addition to Heusler alloys, certain non-Heusler alloys also require significant post-deposition annealing and can be used in the method of this invention in place of the Heusler alloys. These non-Heusler alloys are of the form (Co_{y}Fe_{(100-y)})_{(100-z)}X_{z} (where X is one or more of Ge, Al, Si or Ga, y is between about 45 and 55 atomic percent, and z is between about 20 and 40 atomic percent).

For a fuller understanding of the nature and advantages of the present invention, reference should be made to the following detailed description taken together with the accompanying figures.

### BRIEF DESCRIPTION OF THE DRAWINGS

FIG. 1 is a schematic top view of a conventional magnetic recording hard disk drive with the cover removed.

FIG. 2 is an enlarged end view of the slider and a section of the disk taken in the direction 2-2 in FIG. 1.

FIG. 3 is a view in the direction 3-3 of FIG. 2 and shows the ends of the read/write head as viewed from the disk.

FIG. 4 is a cross-sectional schematic view of a prior art CPP MR read head having an antiparallel-free (APF) structure as the free layer and showing the stack of layers located between the magnetic shield layers.

FIG. 5 is a flow chart illustrating the method of this invention.

FIG. 6 is a flow chart illustrating a modification to the method shown by the flow chart of FIG. 5.

FIG. 7 is a M-H loop for an APF structure made according to the method shown in the flow chart of FIG. 6.

### DETAILED DESCRIPTION OF THE INVENTION

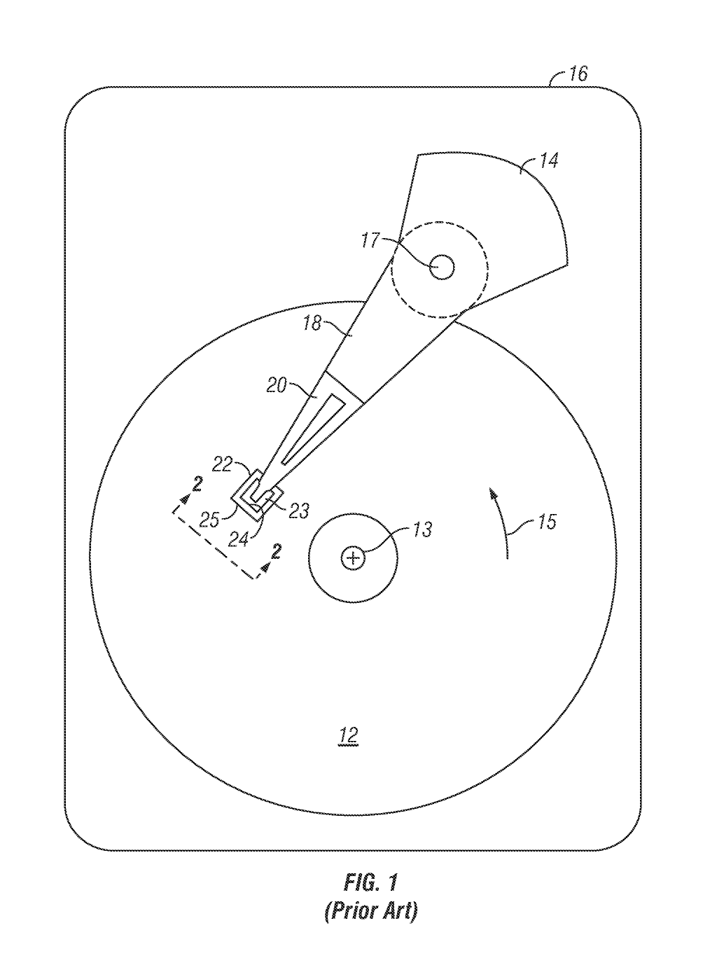

The CPP magnetoresistive (MR) sensor made according to this invention has application for use in a magnetic recording disk drive, the operation of which will be briefly described with reference to FIGS. 1-3. FIG. 1 is a block diagram of a conventional magnetic recording hard disk drive. The disk drive includes a magnetic recording disk 12 and a rotary voice coil motor (VCM) actuator 14 supported on a disk drive housing or base 16. The disk 12 has a center of rotation 13 and is rotated in direction 15 by a spindle motor (not shown) mounted to base 16. The actuator 14 pivots about axis 17 and includes a rigid actuator arm 18. A generally flexible suspension 20 includes a flexure element 23 and is attached to the end of arm 18. A head carrier or air-bearing slider 22 is attached to the flexure 23. A magnetic recording read/write head 24 is formed on the trailing surface 25 of slider 22. The flexure 23 and suspension 20 enable the slider to “pitch” and “roll” on an air-bearing generated by the rotating disk 12. Typically, there are multiple disks stacked on a hub that is rotated by the spindle motor, with a separate slider and read/write head associated with each disk surface.

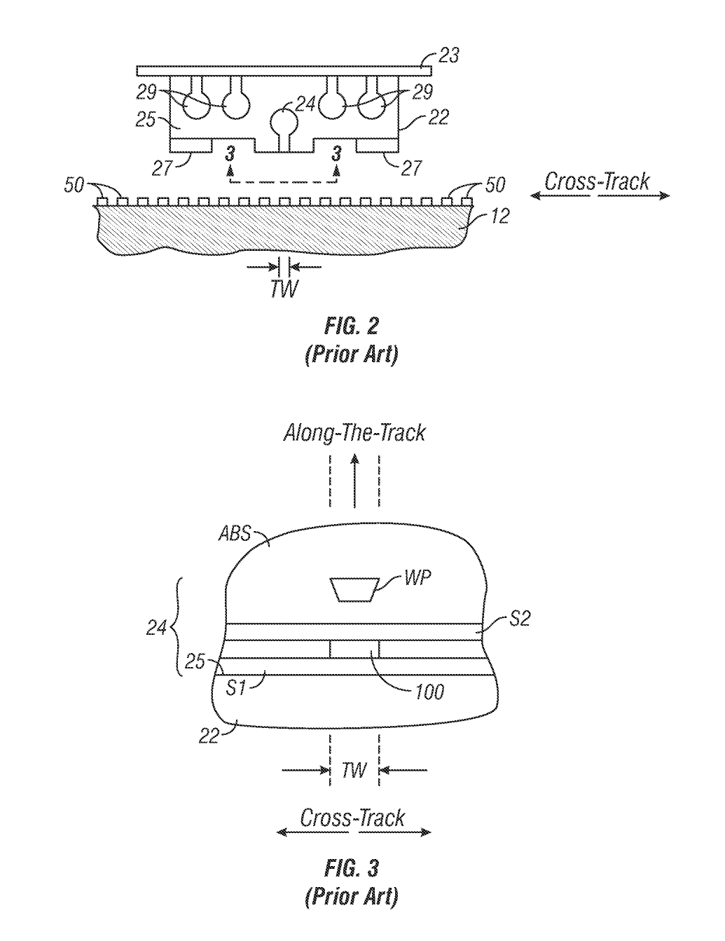

FIG. 2 is an enlarged end view of the slider 22 and a section of the disk 12 taken in the direction 2-2 in FIG. 1. The slider 22 is attached to flexure 23 and has an air-bearing surface (ABS) 27 facing the disk 12 and a trailing surface 25 generally perpendicular to the ABS. The ABS 27 causes the airflow from the rotating disk 12 to generate a bearing of air that supports the slider 20 in very close proximity to or near contact with the surface of disk 12. The read/write head 24 is formed on the trailing surface 25 and is connected to the disk drive read/write electronics by electrical connection to terminal pads 29 on the trailing surface 25. As shown in the sectional view of FIG. 2, the disk 12 is a patterned-media disk with discrete data tracks 50 spaced-apart in the cross-track direction, one of which is shown as being aligned with read/write head 24. The discrete data tracks 50 have a track width TW in the cross-track direction and may be formed of continuous magnetizable material in the circumferential direction, in which case the patterned-media disk 12 is referred to as a discrete-track-media (DTM) disk. Alternatively, the data tracks 50 may contain discrete data islands spaced-apart along the tracks, in which case the patterned-media disk 12 is referred to as a bit-patterned-media (BPM) disk. The disk 12 may also be a conventional continuous-media (CM) disk wherein the recording layer is not patterned, but is a continuous layer of recording material. In a CM disk the concentric data tracks with track width TW are created when the write head writes on the continuous recording layer.

FIG. 3 is a view in the direction 3-3 of FIG. 2 and shows the ends of read/write head 24 as viewed from the disk 12. The read/write head 24 is a series of thin films deposited and lithographically patterned on the trailing surface 25 of slider 22. The write head includes a perpendicular magnetic write pole (WP) and may also include trailing and/or side shields (not shown). The CPP MR sensor or read head 100 is located between two magnetic shields S1 and S2. The shields S1, S2 are formed of magnetically permeable material and are electrically conductive so they can function as the electrical leads to the read head 100. The shields function to shield the read head 100 from recorded data bits that are neighboring the data bit being read. Separate electrical leads may also be used, in which case the read head 100 is formed in contact with layers of electrically conducting lead material, such as tantalum, gold, or copper, that are in contact with the shields S1, S2. FIG. 3 is not to scale because of the difficulty in showing very small dimensions. Typically each shield S1, S2 is several microns thick in the along-the-track direction, as compared to the total thickness of the read head 100 in the along-the-track direction, which may be in the range of 20 to 40 nm.

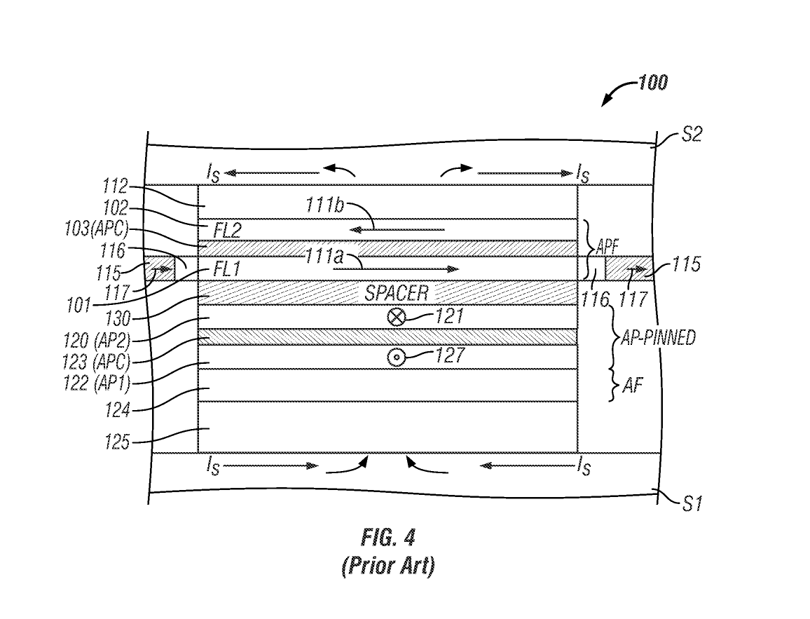

FIG. 4 is an enlarged sectional view showing the layers making up sensor 100 as would be viewed from the disk. Sensor 100 is a CPP MR read head comprising a stack of layers formed between the two magnetic shield layers S1, S2 that are typically electroplated NiFe alloy films. The shields S1, S2 are formed of electrically conductive material and thus may also function as electrical leads for the sense current I_{S}, which is directed generally perpendicularly through the layers in the sensor stack. Alternatively, separate electrical lead layers may be formed between the shields S1, S2 and the sensor stack. The lower shield S1 is typically polished by chemical-mechanical polishing (CMP) to provide a smooth substrate for the growth of the sensor stack. This may leave an oxide coating which can be removed with a mild etch just prior to sensor deposition. The sensor layers include an antiparallel (AP) pinned (AP-PINNED) structure, an antiparallel free (APF) structure, and a nonmagnetic spacer layer 130 between the AP-PINNED and APF structures.

The pinned ferromagnetic layer in a CPP MR sensor may be a single pinned layer or an antiparallel (AP) pinned structure like that shown in FIG. 4. An AP-pinned structure has first (AP1) and second (AP2) ferromagnetic layers separated by a nonmagnetic antiparallel coupling (APC) layer with the magnetization directions of the two AP-pinned ferromagnetic layers oriented substantially antiparallel. The AP2 layer, which is in contact with the nonmagnetic APC layer on one side and the sensor's electrically nonmagnetic spacer layer on the other side, is typically referred to as the reference layer 120. The AP1 layer, which is typically in contact with an antiferromagnetic or hard magnet pinning layer on one side and the nonmagnetic APC layer on the other side, is typically referred to as the pinned layer 122. Instead of being in contact with a hard magnetic layer, AP1 by itself can be comprised of hard magnetic material so that AP1 is in contact with an underlayer on one side and the nonmagnetic APC layer on the other side. The AP-pinned structure minimizes the net magnetostatic coupling between the reference/pinned layers and the CPP MR free ferromagnetic layer. The AP-pinned structure, also called a “laminated” pinned layer, and sometimes called a synthetic antiferromagnet (SAF), is described in U.S. Pat. No. 5,465,185.

The pinned layer in the CPP MR sensor in FIG. 4 is a well-known AP-pinned structure with reference ferromagnetic layer 120 (AP2) and a lower ferromagnetic layer 122 (AP1) that are antiferromagnetically coupled across a nonmagnetic coupling layer. The nonmagnetic coupling layer is depicted as antiparallel coupling (APC) layer 123. The APC layer 123 is typically Ru, Ir, Rh, Cr, Os or alloys thereof. The AP1 and AP2 layers are typically formed of crystalline CoFe or NiFe alloys, or a multilayer of these materials, such as a CoFe/NiFe bilayer. The AP1 and AP2 ferromagnetic layers have their respective magnetization directions 127, 121 oriented antiparallel. The AP1 layer 122 may have its magnetization direction pinned by being exchange-coupled to an antiferromagnetic (AF) layer 124 as shown in FIG. 4. The AF layer 124 is typically one of the antiferromagnetic Mn alloys, e.g., PtMn, NiMn, FeMn, IrMn, PdMn, PtPdMn or RhMn, which are known to provide relatively high exchange-bias fields. Typically the Mn alloy material provides lower or little exchange-biasing in the as-deposited state, but when annealed provides stronger exchange-biasing of the pinned ferromagnetic layer 122.

Alternatively, the AP-pinned structure may be “self-pinned” or it may be pinned by a hard magnetic layer such as Co₁₀₀₋ₓPtₓ or Co_{100-x-y}PtₓCr_{y} (where x is about between 8 and 30 atomic percent). Instead of being in contact with an antiferromagnetic pinning layer, AP1 layer 122 by itself can be comprised of hard magnetic material so that it is in contact with an underlayer on one side and the nonmagnetic APC layer 123 on the other side. In a “self pinned” sensor the AP1 and AP2 layer magnetization directions 127, 121 are typically set generally perpendicular to the disk surface by magnetostriction and the residual stress that exists within the fabricated sensor. It is desirable that the AP1 and AP2 layers have similar moments. This assures that the net magnetic moment of the AP-pinned structure is small so that magnetostatic coupling to the APF structure is minimized and the effective pinning field of the AF layer 124, which is approximately inversely proportional to the net magnetization of the AP-pinned structure, remains high. In the case of a hard magnet pinning layer, the hard magnet pinning layer moment needs to be accounted for when balancing the moments of AP1 and AP2 to minimize magnetostatic coupling to the free layer.

The APF structure comprises a first free ferromagnetic layer 101 (FL1), second free ferromagnetic layer 102 (FL2), and an antiparallel (AP) coupling (APC) layer 103. APC layer 103, such as a thin (between about 4 Å and 10 Å) Ru film, couples FL1 and FL2 together antiferromagnetically with the result that FL1 and FL2 maintain substantially antiparallel magnetization directions in the quiescent state, as shown by arrows 111a, 111b, respectively. The antiferromagnetically-coupled FL1 and FL2 rotate substantially together in the presence of a magnetic field, such as the magnetic fields from data recorded in a magnetic recording medium. The net magnetic moment/area of the APF structure (represented by the difference in magnitudes of arrows 111a, 111b) is (M1*t1−M2*t2), where M1 and t1 are the saturation magnetization and thickness, respectively, of FL1, and M2 and t2 are the saturation magnetization and thickness, respectively, of FL2. Thus the thicknesses of FL1 and FL2 are chosen to obtain the desired net free layer magnetic moment for the sensor.

A seed layer 125 may be located between the lower shield layer Si and the AP-pinned structure. If AF layer 124 is used, the seed layer 125 enhances the growth of the AF layer 124. The seed layer 125 is typically one or more layers of NiFeCr, NiFe, CoFe, CoFeB, CoHf, Ta, Cu or Ru. A capping layer 112 is located between FL2 102 and the upper shield layer S2. The capping layer 112 provides corrosion protection and may be a single layer or multiple layers of different materials, such as Ru, Ta, NiFe or Cu.

A ferromagnetic biasing layer 115, such as a CoPt or CoCrPt hard magnetic bias layer, is also typically formed outside of the sensor stack near the side edges of FL1 101. The biasing layer 115 is electrically insulated from FL1 101 by insulating regions 116, which may be formed of alumina, for example. The biasing layer 115 has a magnetization 117 generally parallel to the ABS and thus longitudinally biases the magnetization 111a of the FL1 101. Thus in the absence of an external magnetic field its magnetization 117 is parallel to the magnetization 111 of FL1 101. The ferromagnetic biasing layer 115 may be a hard magnetic bias layer or a ferromagnetic layer that is exchange-coupled to an antiferromagnetic layer.

In the presence of an external magnetic field in the range of interest, i.e., magnetic fields from recorded data on the disk 12, the magnetization directions 111a, 111b of the APF structure will rotate together while the magnetization direction 121 of reference layer 120 will remain fixed and not rotate. Thus when a sense current I_{S} is applied from top shield S2 perpendicularly through the sensor stack to bottom shield S1, the magnetic fields from the recorded data on the disk will cause rotation of the magnetization directions 111a, 111b of the APF structure relative to the reference-layer magnetization 121, which is detectable as a change in electrical resistance.

The CPP MR sensor described above and illustrated in FIG. 4 may be a CPP GMR sensors, in which case the nonmagnetic spacer layer 130 would be formed of an electrically conducting material, typically a metal like Cu, Au or Ag. Alternatively, the CPP MR sensor may be CPP tunneling MR (CPP-TMR) sensor, in which case the nonmagnetic spacer layer 130 would be a tunnel barrier formed of an electrically insulating material, like TiO₂, MgO or Al₂O₃.

The typical materials used for FL1 and FL2 are crystalline CoFe or NiFe alloys, or a multilayer of these materials, such as a CoFe/NiFe bilayer. Heusler alloys, i.e., metallic compounds having a Heusler alloy crystal structure like Co₂MnX, for example, have been proposed for use in APF structures in CPP MR sensors, as described in U.S. Pat. No. 7,580,229 B2, assigned to the same assignee as this application. However, it has been discovered, as part of the development of the method of this invention, that the high-temperature annealing required to chemically order the Heusler alloys can adversely affect the APF structure and thus the magnetic performance of the sensor. Certain non-Heusler alloys of the form CoFeX (where X is one or more of Ge, Al, Si or Ga) also require post-deposition annealing and have been proposed for use in APF structures. The annealing of these non-Heusler alloys will also likely adversely affect the magnetic performance of the sensor.

In this invention, FL2 102 is formed of a typical ferromagnetic material. However, FL1 101 is a Heusler alloy, i.e., a metallic compound having a Heusler alloy crystal structure, of the type Co₂MnX (where X is one or more of Ge, Si, or Al), or Co₂FeZ (where Z is one or more of Ge, Si, Al or Ga) or (CoFeₓCr₍₁₋ₓ₎Al (where x is between 0 and 1). FL1 101 may be a single layer of a Heusler alloy or a bilayer of a Heusler alloy first layer and a ferromagnetic nanolayer of a material other than a Heusler alloy (like a CoFe or NiFe alloy having a thickness between about 2 to 15 Å) between the Heusler alloy first layer and the APC layer 103. These Heusler alloys are known to have high spin-polarization and result in an enhanced MR in a CPP spin-valve structure. These alloys require high-temperature annealing to produce the required chemical ordering or high spin-polarization.

As an alternative to the above-described Heusler alloys, FL1 101 may be formed of a non-Heusler alloy of the form (Co_{y}Fe_{(100-y)})_{(100-z)}X_{z} (where X is one or more of Ge, Al, Si or Ga, y is between about 45 and 55 atomic percent, and z is between about 20 and 40 atomic percent). This material also requires significant post-deposition annealing. The preferred type of CoFeX material is CoFeGe, which is described in U.S. Pat. No. 7,826,182 B2 for use in CPP-MR sensors, including use in APF structures.

This invention is a method for making a CPP MR sensor like that shown in FIG. 4 with an APF structure that has a Heusler alloy or a non-Heusler CoFeX alloy as FL1 and a typical or conventional ferromagnetic material, i.e., a non-Heusler alloy, as FL2. In the conventional method for fabrication of a CPP MR sensor like that shown in FIG. 4, all of the layers from seed layer 125 to capping layer 112 are deposited as full films on S1, typically by sputter deposition. Then the structure is annealed in a magnetic field (either in the deposition chamber, or more commonly in an external annealing oven) to produce the required exchange biasing effect of the AF layer 122, which is typically PtMn or IrMn. The structure is then lithographically patterned and etched to define the sensor track width (TW) on the ABS (see FIG. 3) and sensor stripe height (SH), i.e., the height of the sensor orthogonal to the ABS. However, it has been discovered, as part of the development of the method of this invention, that if this conventional method is used with Heusler alloy materials in an APF structure, the high-temperature annealing can adversely affect the APF structure and thus the magnetic performance of the sensor.

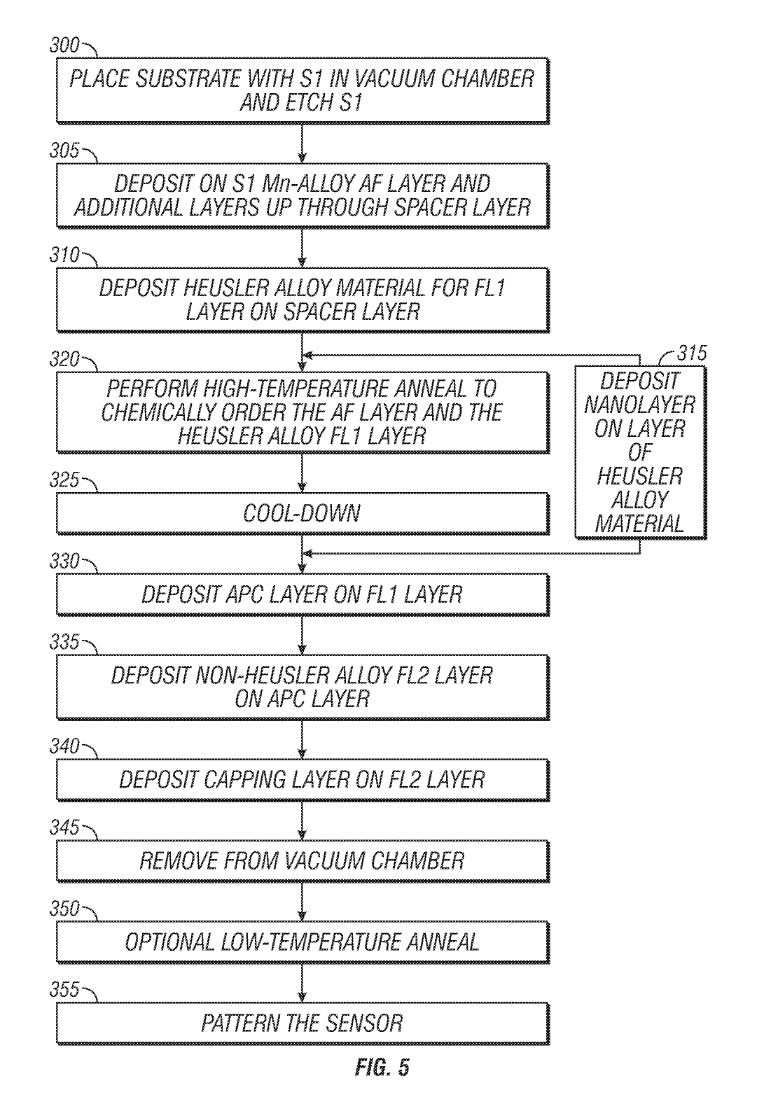

FIG. 5 illustrates the method of this invention as steps 300 to 355. The substrate with shield layer S1 is placed in the vacuum chamber where the sputter deposition will be performed, and S1 is etched to remove an oxide layer (step 300). The layers, including the AF layer which must be annealed, up through and including the spacer layer are deposited on S1 (step 305). The material that will make up the Heusler alloy is sputter deposited on the spacer layer at step 310. For example, if the Heusler alloy is to be chemically-ordered Co₂MnSi, then a single target or multiple targets with Co, Mn and Si are used to sputter deposit a disordered layer containing the proper relative amounts of these elements. The high-temperature anneal (step 320) is then performed in the vacuum chamber before the deposition of the APC layer and is an anneal at about 300-500 ° C. for about 5-30 minutes. This results in the microstructural improvement (ordering) of both the AF layer and the Heusler alloy FL1 layer. After cool-down at step 325, which may be for about 5-30 minutes to reduce the temperature of the substrate to less than about 100° C., the APC layer is deposited on the Heusler alloy FL1 layer (step 330) and the non-Heusler alloy FL2 layer, e.g., a CoFe alloy layer, is deposited on the APC layer (step 335). If the FL1 layer is to be a bilayer of a Heusler alloy first layer and a nanolayer (like a CoFe alloy), then the optional nanolayer may be deposited (step 315) either before the high-temperature anneal step 320 or after the cool-down step 325. After deposition of the capping layer (step 340), the structure is removed from the vacuum chamber (step 345). An optional low-temperature anneal (step 350) can then be performed at 200-250 ° C. for 1-5 hours. The purpose of the optional low-temperature anneal is to further anneal the AF layer to improve the exchange biasing with the pinned layer (AP1 layer 122 in FIG. 4). The structure is then patterned to form the sensor (step 355).

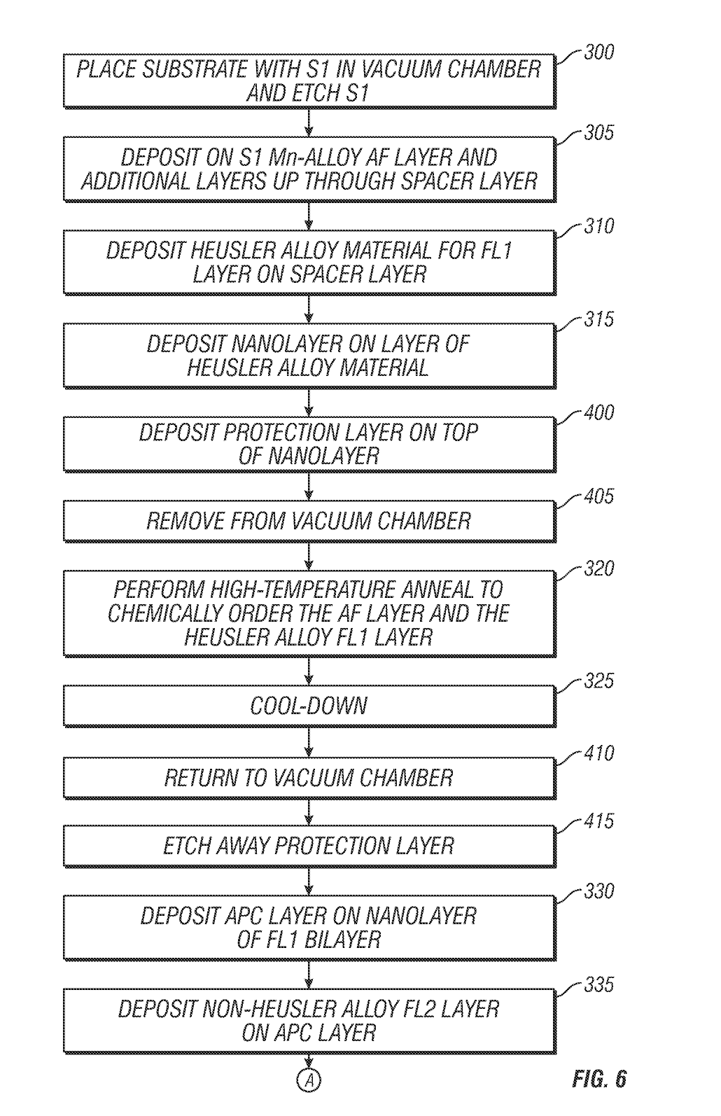

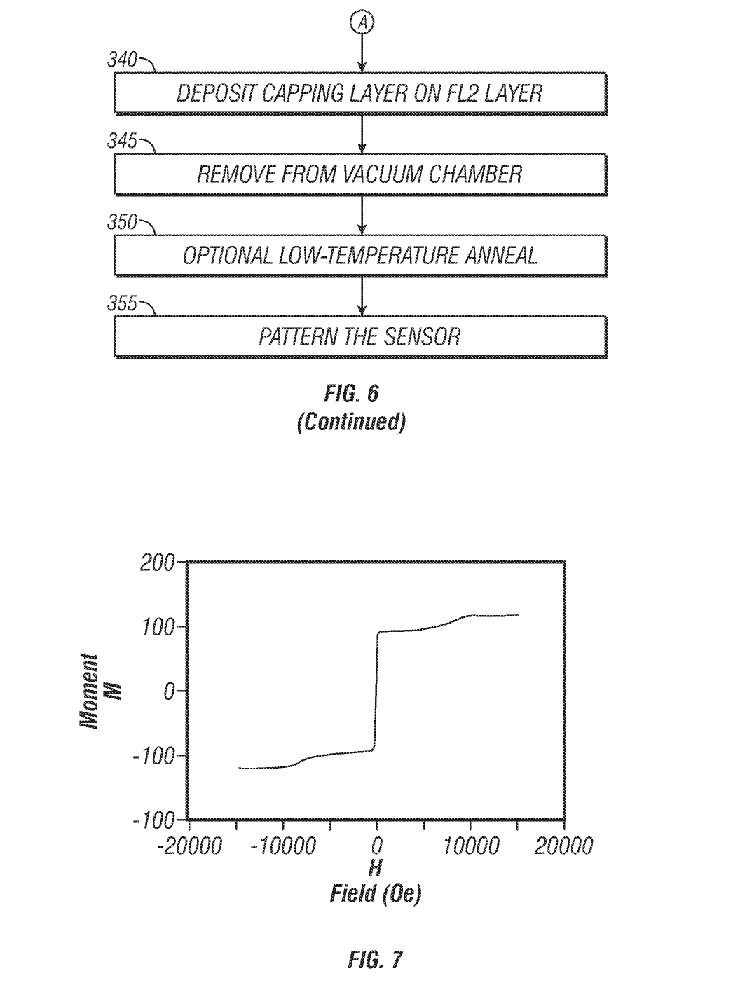

FIG. 6 illustrates a modification to the method of FIG. 5. This modification will be explained for an example where the FL1 layer is to be a bilayer of a Heusler alloy first layer and a nanolayer (like a CoFe alloy), so the optional nanolayer is deposited on the layer of Heusler material at step 315. Then at step 400 a protection layer is deposited on the nanolayer. The protection layer may be, for example, a layer of Ru, Ta, Ti, Al, CoFe, CoFeB or NiFe deposited to a thickness of about 30-100 Å. The substrate is then removed from the vacuum chamber (step 405) and the high-temperature anneal (step 320) is performed with the protection layer covering the nanolayer and the layer Heusler alloy material below the nanolayer. After cool-down at step 325, the substrate is then returned to a vacuum chamber (step 410) and the protection layer is etched away, for example by Argon RF etching or ion milling, to expose the underlying FL1 bilayer (step 415). The APC layer is deposited on the FL1 bilayer (step 330) and the non-Heusler alloy FL2 layer is deposited on the APC layer (step 335). After deposition of the capping layer (step 340), the structure is removed from the vacuum chamber (step 345). The optional low-temperature anneal (step 350) can then be performed prior to patterning the sensor (step 355).

FIG. 7 is a M-H loop for an APF structure made according to the method of FIG. 6 and formed on a bilayer underlayer of 50 Å Ta/40 Å Ag. The FL1 bilayer is an 80 Å Co₂MnSi Heusler alloy layer with a 8 Å Co₅ₒFe₅₀ nanolayer. The APC layer is a 8 Å Ru layer and the FL2 layer is a 10 Å Co₅₀Fe₅₀ layer. The capping layer is a 70 Å Ru layer. The process used in this case was according to FIG. 5, and thus no protection layer was used on the nanolayer. The high-temperature annealing was done at 283° C. for 30 minutes. FIG. 7 shows strong antiparallel coupling of the magnetizations of FL1 and FL2 at fields up to about 7500 Oe. At fields about 8000 Oe, the antiparallel coupling is overcome and the magnetizations of FL1 and FL2 become parallel. For the same APF structure as described above with respect to FIG. 7, but where the FL1bilayer/Ru APC layer/FL2 layer were annealed together under the same annealing conditions, no significant antiparallel coupling was observed.

If the non-Heusler alloy (Co_{y}Fe_{(100-y)})_{100-z)}Ge_{z} (where y is between about 45 and 55 atomic percent, and z is between about 20 and 40 atomic percent) is used as FL1, it would have a typical thickness of about 30 to 70 Å and would be annealed at about 250 to 350° C. for about 5 to 60 minutes.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A method for making a magnetoresistive sensor having an antiparallel free (APF) structure comprising:
providing a substrate;
depositing on the substrate a layer of material selected from a Heusler alloy material and a non-Heusler alloy material of the form (Co_{y}Fe_{(100-y)})_{100-z)}X_{z} (where X is one or more of Ge, Al, Si or Ga, y is between about 45 and 55 atomic percent, and z is between about 20 and 40 atomic percent);
annealing said selected Heusler alloy material or non-Heusler alloy material to form a first free layer (FL1);
depositing on the FL1 layer an antiparallel coupling (APC) layer; and
depositing on the APC layer a second free layer (FL2) comprising a ferromagnetic material other than a Heusler alloy.

2. The method of claim 1 further comprising, prior to said annealing, depositing on the layer of said selected Heusler alloy material or non-Heusler alloy material a nanolayer comprising a ferromagnetic material other than a Heusler alloy, and wherein said annealing forms a bilayer FL 1 comprising said selected Heusler alloy material or non-Heusler alloy material and said nanolayer.

3. The method of claim 1 further comprising, after said annealing and prior to depositing said APC layer, depositing on the layer of said selected Heusler alloy material or non-Heusler alloy material a nanolayer comprising a ferromagnetic material other than a Heusler alloy.

4. The method of claim 1 further comprising, prior to said annealing, depositing on the layer said selected Heusler alloy material or non-Heusler alloy material a protection layer;
and, after annealing and prior to depositing said APC layer, removing said protection layer.

5. The method of claim 4 wherein depositing a protection layer comprises depositing a layer selected from Ru, Ta, Ti, Al, Mg, CoFe, CoFeB and NiFe to a thickness between 30 and 100 Å.

6. The method of claim 1 wherein the layer of selected material is a Heusler alloy and wherein annealing the Heusler alloy material forms a first free layer (FL1) comprising a Heusler alloy layer selected from Co₂MnX (where X is one of Ge, Si, or Al), Co₂FeZ (where Z is one of Ge, Si, Al or Ga) and CoFeₓCr₍₁₋ₓ₎Al (where x is between 0 and 1).

7. The method of claim 1 wherein the layer of selected material is the non-Heusler alloy (Co_{y}Fe_{(100-y)})_{(100-z)}Ge_{z} (where y is between about 45 and 55 atomic percent, and z is between about 20 and 40 atomic percent).

8. The method of claim 1 further comprising, prior to depositing said selected Heusler alloy material or non-Heusler alloy material, depositing on the substrate a layer of Mn-alloy material capable of becoming antiferromagnetic and a ferromagnetic pinned layer in contact with said Mn-alloy layer; and wherein said annealing improves the microstructure of said Mn-alloy so as to form a Mn-alloy antiferromagnetic layer which provides exchange biasing to said ferromagnetic pinned layer.

9. The method of claim 8 wherein said annealing is a first annealing step at a first temperature and further comprising, after depositing said FL2, performing a second annealing step at a temperature lower than said first temperature.

10. The method of claim 8 further comprising, after depositing said layer of Mn-alloy material and prior to depositing said selected Heusler alloy material or non-Heusler alloy material, depositing a nonmagnetic spacer layer, and wherein depositing said selected Heusler alloy material or non-Heusler alloy material comprises depositing said selected Heusler alloy material or non-Heusler alloy material on said spacer layer.

11. The method of claim 10 wherein depositing a nonmagnetic spacer layer comprises depositing a layer of an electrically conducting material.

12. The method of claim 12 wherein depositing a nonmagnetic spacer layer comprises depositing a layer of an electrically insulating tunnel barrier layer.

13. A method for making a magnetoresistive sensor having an antiparallel free (APF) structure comprising:
providing a substrate;
depositing on the substrate a layer of Mn-alloy material capable of becoming antiferromagnetic;
depositing on the Mn-alloy layer a ferromagnetic pinned layer;
depositing on the pinned layer a nonmagnetic spacer layer;
depositing on the spacer layer a layer of Heusler alloy material;
depositing on the layer of Heusler alloy material a nanolayer of a ferromagnetic material other than a Heusler alloy material;
annealing the layer of Heusler alloy material to form a first free layer (FL1) comprising a bilayer of a Heusler alloy layer selected from Co₂MnX (where X is one of Ge, Si, or Al), Co₂FeZ (where Z is one of Ge, Si, Al or Ga) and CoFeₓCr₍₁₋ₓ₎Al (where x is between 0 and 1) and said ferromagnetic nanolayer;
depositing on said ferromagnetic nanolayer of the FL1 an antiparallel coupling (APC) layer; and
depositing on the APC layer a second free layer (FL2) comprising a ferromagnetic material other than a Heusler alloy; and wherein said annealing improves the microstructure of said Mn-alloy so as to form a Mn-alloy antiferromagnetic layer and exchange bias said ferromagnetic pinned layer.

14. The method of claim 13 further comprising, prior to said annealing, depositing on the nanolayer layer of the FL1 a protection layer; and, after annealing and prior to depositing said APC layer, removing said protection layer.

15. The method of claim 14 wherein depositing a protection layer comprises depositing a layer selected from Ru, Ta, Ti, Al, Mg, CoFe, CoFeB and NiFe to a thickness between 30 and 100 Å.

16. The method of claim 13 wherein said annealing is a first annealing step at a first temperature and further comprising, after depositing said FL2, performing a second annealing step at a temperature lower than said first temperature.

17. The method of claim 13 wherein depositing a nonmagnetic spacer layer comprises depositing a layer of an electrically conducting material.

18. The method of claim 13 wherein depositing a nonmagnetic spacer layer comprises depositing a layer of an electrically insulating tunnel barrier.

19. The method of claim 13 wherein depositing a ferromagnetic pinned layer comprises depositing an AP-pinned structure having a ferromagnetic AP1 layer in contact with said Mn-alloy layer, a ferromagnetic reference AP2 layer, and a nonmagnetic coupling layer between AP1 and AP2, and wherein depositing said nonmagnetic spacer layer comprises depositing said nonmagnetic spacer layer on the AP2 layer.
